(19) United States
(12) Patent Application Publication
(10) Pub. No.: US 2002/0191240 A1
(43) Pub. Date: Dec. 19, 2002

(54) Virtual filter-bandwidth reduction and frequency stabilization via heterodyning

(76) Inventors: Michael H. Myers, Poway, CA (US); Clark Guest, San Diego, CA (US)

Correspondence Address: ALL OPTICAL NETWORKS, INC., 9440 CARROLL PARK DRIVE, SAN DIEGO, CA, 92121, US

(21) Appl. No.: 10/155,100

(22) Filed: May 23, 2002

Related U.S. Application Data
(60) Provisional application No. 60/292,887, filed on May 23, 2001.

(51) Int. Cl. H04B 10/00; G02B 6/28

(52) U.S. Cl. 359/109; 385/24

(57) ABSTRACT

A virtual filter-bandwidth reduction and frequency stabilization via heterodyning shifts the signal to be filtered up and down as it passes through two cascaded fixed filters whereas the alternative structure shifts the filter center frequencies of two cascaded filters up and down respectively and leaves the signal to be filtered alone. Two identical cascaded fixed filters are used to provide the filtering.

### RELATED APPLICATION

The present application claims the benefit of priority to U.S. Provisional Patent Application Serial No. 60/292,887, filed May 23, 2001, currently co-pending and fully incorporated herein by this reference.

### BACKGROUND OF THE INVENTION

The alternative to the process of the present invention is to physically tune filter. For example, two identical filter of bandwidth B can be cascaded, where the center frequencies are offset up and down respectively. This produces a passband which is defined by the lower cutoff of the upshifte3d filter and the higher cutoff of the downshifted filter. The job of shifting the filter is distinctly different from that of shifting the frequency of the sign al to be filter inside the filters.

### PURPOSE OF THE INVENTION

In analog or digital signal processing in any band, the filtering effects of any existing bandpass high pass or low pass on any signal which is to be filtered may be modified so as to decrease or increase the high pass or lowpass cutoff frequency or change the passband cutoff frequencies relative to the signal so as to achieve a virtual bandwidth reduction. The reasons for this may be the need to use an existing filter that has a wider passband than desired to filter a signal to a narrower passband. For example, passbands achieved using an optical Bragg bandpass filter may not be as narrow as is needed to filter a particular signal due to the physical limitations of achievable bandwidth imposed by physical filter length. A second problem that can be solved is to use heterodyning to keep the desired signal centered inside the filter by removing the combination of filter center frequency drift with temperature and the signal carrier drift, for example in an optical system, due to laser frequency drift. Both of these problems may be solved by heterodyning the signal inside the filter as explained herein.

### DESCRIPTION OF THE PRESENT INVENTION

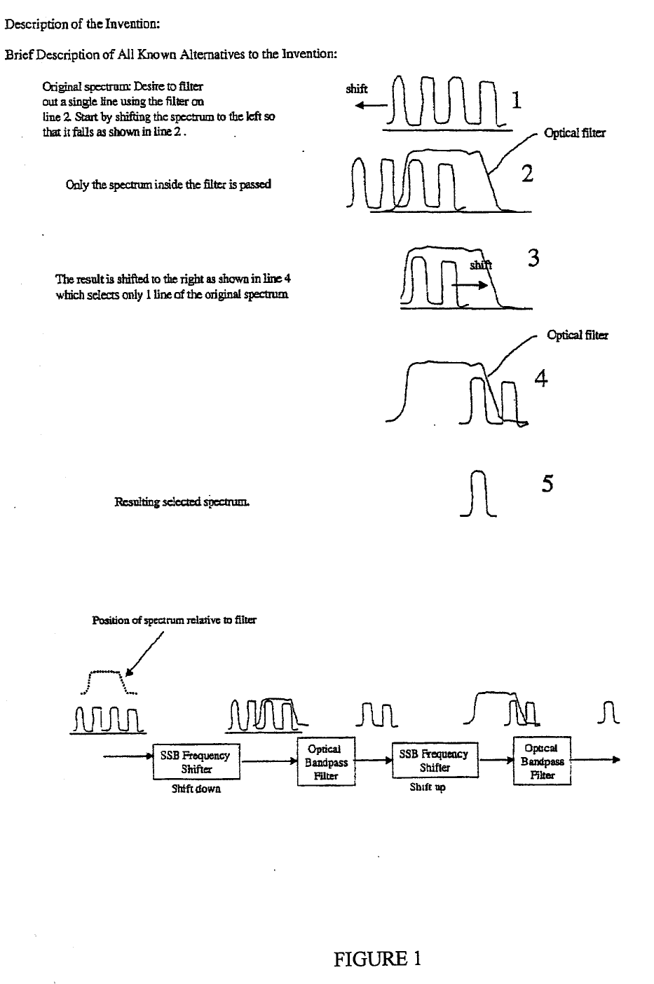

See FIG. 1. From reviewing FIG. 1, the present invention provides an alternative to the process of physically tuning a filter.

The invention shifts the signal to be filtered up and down as it passes through two cascaded fixed filters whereas the alternative structure shifts the filter center frequencies of two cascaded filters up and down respectively and leaves the signal to be filtered alone. The present invention works with two identical cascaded fixed filters while the alternative requires two cascaded filters of different center frequencies. Advantages with the present invention includes the narrowing of the passband achievable in optical filters above what cascading would achieve. Also, the present invention offers the potential to narrow the filtering of drifting frequency signals.

We Claim:

1. A virtual filter-bandwidth reduction and frequency stabilzation method, comprising;
receiving an optical data signal;
shifting down the SSB filter to a shifted data signal;
passing said shifted data signal through an optical bandpass filter;
shifting up said shifted data signal; and
passing said shifted up data signal through a second optical bandpass filter to provide a filtered output signal.
